(19) United States
(12) Patent Application Publication
(10) Pub. No.: US 2014/0003354 A1
(43) Pub. Date: Jan. 2, 2014

(54) PROVIDING A SYSTEM INFORMATION MESSAGE HAVING RETRY PARAMETER VALUES

(71) Applicants: Ozgur EKICI, Escondido, CA (US); M. Khaledul ISLAM, Ottawa (CA)

(72) Inventors: Ozgur EKICI, Escondido, CA (US); M. Khaledul ISLAM, Ottawa (CA)

(21) Appl. No.: 13/537,269

(22) Filed: Jun. 29, 2012

(51) Int. Cl. H04W 74/00

(52) U.S. Cl. 370/329

(57) ABSTRACT

A system information message is communicated between a wireless access network node and an electronic device, where the system information message includes multiple retry time values for different network domains, for different connection types, or for different combinations of network domains and connection types.

### BACKGROUND

To perform communications using a wireless access network, an electronic device can perform a connection establishment procedure to establish a connection with the wireless access network. The network establishment procedure involves the electronic device sending a connection establishment request to the wireless access network. In some cases, such as due to congestion, fault, error, or other issue, the connection establishment procedure may not successfully complete on a first attempt by the electronic device.

### BRIEF DESCRIPTION OF THE DRAWINGS

Some embodiments are described with respect to the following figures:

FIG. 1 is a block diagram of an example arrangement including a wireless access network and a mobile device in accordance with some implementations;

FIG. 2 is a flow diagram of a retry parameter configuration process according to some implementations;

FIGS. 3-5 are message flow diagrams of channel establishment procedures according to some implementations; and

FIG. 6 is a block diagram of an example system capable of incorporating some implementations.

### DETAILED DESCRIPTION

### Introduction

Various wireless access technologies have been proposed or implemented to enable electronic devices (e.g. desktop computers, notebook computers, tablet computers, personal digital assistants, smartphones, game devices, etc.) to perform communications with other endpoints. Examples of wireless access technologies include GSM (Global System for Mobile communications) and UMTS (Universal Mobile Telecommunications System) technologies, which are defined by the Third Generation Partnership Project (3GPP). Enhancements to the UMTS technology are provided by Long Term Evolution (LTE) standards from 3GPP. The LTE standards include the initial LTE standard as well as the LTE-Advanced standard. The LTE standards are also referred to as the EUTRA (Evolved Universal Terrestrial Radio Access) standards.

In addition to the foregoing wireless access technologies, other example wireless access technologies include the CDMA2000 (Code Division Multiple Access 2000) technology, as defined by 3GPP2; the WiMAX (Worldwide Interoperability for Microwave Access) technology, as defined by IEEE 802.16; or others.

A coverage area of a wireless communications network (employing any of the foregoing wireless access technologies) includes an arrangement of cells, where each cell refers to a specific region within the coverage area that includes a wireless access network node (e.g. a base station) that is able to wirelessly communicate with electronic devices, such as mobile devices, in the cell. As used here, a “cell” can refer to an entire cell (which can have multiple sectors), or a cell sector, or any other segment of an entire cell.

In the ensuing discussion, reference is made to mobile devices that are able to communicate using a wireless access network. Note that techniques or mechanisms according to some embodiments can also be applied with other types of electronic devices that are capable of wireless communications.

To communicate data between a mobile device and a wireless access network, the mobile device can perform a channel establishment procedure with the wireless access network to obtain various resources of the wireless access network. The resources can include radio resources such as channels (e.g. traffic channels, control channels and so forth). The type of channel establishment procedure used by the mobile device can depend upon which mode the mobile device is in. In some examples, the mobile device can be in an idle mode or a connected mode. In a more specific example, the idle mode and connected mode can be according to the Radio Resource Control (RRC) protocol, as described in Third Generation Partnership Project (3GPP) Technical Specification (TS) 25.331 and/or TS 36.331 for the UMTS and LTE wireless access technologies, respectively. The RRC protocol can define functionality associated with assignment, configuration, and release of radio resources between a mobile device and a network node in a wireless access network.

In the RRC connected mode, the mobile device has a radio connection to the wireless access network, and the mobile device can exchange signals with the wireless access network and perform other operations. In the RRC idle mode, the mobile device does not have a radio connection with the wireless access network. RRC idle mode and connected mode behaviors are described in further detail in 3GPP TS 25.303, 25.304 and 25.331 for UMTS and 3GPP TS 36.304 and 36.331 for LTE.

Although reference is made to the RRC connected mode and RRC idle mode, it is noted that in other implementations, a mobile device can have idle and connected modes according to other protocols.

From the idle mode, the mobile device can perform a radio connection establishment procedure such as an RRC connection establishment procedure. The RRC connection establishment procedure can be initiated based on the mobile device sending an access request such as an rrcConnectionRequest message to the wireless access network.

On the other hand, if the mobile device is in a connected mode, where the mobile device already has a radio connection (e.g. an RRC connection), the mobile device can submit a different access request to obtain a resource for performing communication with the wireless access network. Such an access request can be a cellUpdate message sent by the mobile device to the wireless access network, for example. The cellUpdate message can be used by the mobile device to obtain a resource, such as a dedicated traffic channel, to allow the mobile device to communicate with the wireless access network. The cellUpdate message can also be used by the mobile device to inform the wireless access network that a cell reselection (change to a different cell) has occurred.

If the wireless access network receives the access request (e.g. rrcConnectionRequest message or cellUpdate message) and determines that the channel establishment procedure can proceed, then the wireless access network sends a positive acknowledgment (e.g. rrcConnectionSetup or cellUpdateConfirm). This response sent by the wireless access network can allocate various radio resources to be used by the mobile device to communicate with the wireless access network.

However, an issue can exist in the wireless access network (e.g. congestion, fault or error) that prevents a channel establishment procedure (initiated by a mobile device from idle mode or connected mode) from completing successfully. As an example, the wireless access network may detect congestion, and may send a rejection message in response to an access request (e.g. rrcConnectionRequest message or cellUpdate message) from the mobile device. Such a rejection message provides an affirmative indication to the mobile device that an issue exists in the wireless access network that prevented successful completion of the channel establishment procedure.

In different examples, the mobile device may not receive a rejection message in response to the access request even though the channel establishment procedure is unable to complete successfully. A mobile device not receiving an explicit message in response to an access request can result from one of the following: (1) wireless access network equipment did not receive the access request from the mobile device due to the presence of the issue (for example, interference or congestion or other poor radio conditions on the uplink radio channel), (2) the wireless access network equipment received the access request from the mobile device but could not respond due to the presence of the issue (for example, insufficient processing resources within the equipment or insufficient radio resources to send the response) or (3) the wireless access network equipment responded to the mobile device but the mobile device did not receive the rejection message sent by the wireless access network equipment due to presence of an issue (for example, interference or congestion or other poor radio conditions on the downlink radio channel).

If a channel establishment procedure fails, then the mobile device can perform a channel establishment retry procedure, in which the mobile device re-transmits one or more access requests until the channel establishment procedure succeeds or until no further retries can be attempted. If a rejection message was received, then the rejection message can specify a wait time that controls an amount of time the mobile device has to wait before transmitting another access request.

In cases where the mobile device does not receive any message, the mobile device can use one or more network-configured retry parameters (as configured by the wireless access network, for example) to perform a channel establishment retry procedure. Examples of retry parameters include retry time values and retry count value. A retry count value can be used by the mobile device to determine a limit on the number of successive re-transmissions of an access request by a mobile device. A retry time value can be used by the mobile device to determine an amount of delay time until the next re-transmission of the access request (where each re-transmission of an access request is considered a “retry”). More generally, a “retry time value” can be used to derive a delay time between successive transmissions of access requests by a mobile device. A retry time value may be expressed as a time value, or may be expressed as an alphanumeric value that a mobile device uses to determine the amount of delay time that a mobile device delays before re-transmission of the access request. The amount of delay time may be referred in this disclosure interchangeably as a retry time period, delay time, or retry time.

In some examples, according to UMTS, the retry time value can be either a T300 timer parameter or a T302 timer parameter. The T300 parameter is used as the retry time between successive transmissions of access requests when the mobile device is in the idle mode. On the other hand, the T302 parameter is used as the retry time when the mobile device is in a connected mode (e.g. CELL_PCH or URA_PCH RRC states).

With UMTS, another network-configured retry parameter that can be used in a channel establishment retry procedure includes a retry count value, which specifies a maximum number of retries that the mobile device can perform. After this maximum number of retries have been performed by the mobile device without receiving either a positive or negative response from the wireless access network, the mobile device stops further retry attempts. According to UMTS, when a mobile device is in the idle mode, an N300 parameter is used as the retry count value. If the mobile device is in a connected mode, then an N302 parameter is used as the retry count value.

The T300, T302, N300, and N302 parameters are configured by the wireless access network—in other words, these parameters can be sent from the wireless access network to the mobile device for storage and use by the mobile device.

In other examples where the wireless access network employs the LTE access technology, the mobile device can similarly employ a channel establishment retry procedure that uses the T300 parameter. However, with LTE, a retry count value (such as N300) may not be employed in the mobile device's channel establishment retry procedure.

The network-configured T300 parameter is described in further detail in 3GPP TS 25.331 and 36.331, while the T302 and N300 and N302 parameters are described in further detail in 3GPP TS 25.331.

Although reference is made to retry parameters used by UMTS and LTE in the present discussion, it is noted that in other implementations, retry parameters associated with other access technologies can be employed.

As noted above, the network-configured retry parameters are configured by the wireless access network at the mobile device. This can be accomplished by using a system information message that contains the retry parameters. A system information message can refer to a message sent by a wireless access network node to a mobile device to configure various settings of the mobile device. In some implementations, a system information message can be broadcast by the wireless access network node to multiple mobile devices. According to UMTS, the retry time values, such as the T300 and T302 parameters, and the retry count values, such as the N300 and N302 parameters, can be communicated in a message referred to as System Information Block Type 1 (SIB1). According to LTE, the retry time value, such as the T300 parameter, can be communicated in a message referred to as System Information Block Type 2 (SIB2).

An issue associated with certain example systems is that the retry parameters are shared across different network domains and/or different connection types. This can reduce flexibility in how the wireless access network is able to control channel establishment retry behavior of mobile devices, which can lead to increased wireless access network traffic and congestion.

In some examples, such as where the UMTS access technology is used, a mobile device may be able to selectively perform packet-switched communications in a packet-switched domain of a communication system, and perform circuit-switched communications in a circuit-switched domain of the communication system. Circuit-switched communications refer to communications between network entities in which a dedicated communications channel or circuit is established between the network entities for the purpose of communicating data between the network entities. In packet-switched communications, packets are communicated across a network, where the packets are routed based on a source network address and a destination network address contained in each packet. In some examples, the packets that are communicated can be packets according to the Internet Protocol (IP).

A packet-switched domain of a communication system can include equipment used for establishing packet-switched communications on behalf of mobile devices, while a circuit-switched domain of the communication system can include equipment used for establishing circuit-switched communications on behalf of mobile devices.

In accordance with some embodiments, different retry parameter values can be specified for use by a mobile device depending upon which network domain (e.g. circuit-switched domain or packet-switched domain) the mobile device is requesting to access. Although reference is made to circuit-switched and packet-switched domains, it is noted that additional network domains can also be provided, where the additional network domains can employ other forms of communications.

In accordance with further or alternative embodiments, instead of specifying different retry parameter values for different network domains, different retry parameter values can be specified for different connection types. A “connection type” can refer to a particular type of access performed by a mobile device to communicate data. There can be multiple different connection types. In some implementations, the different connection types can be identified by an establishment cause, which refers to information that indicates the cause or reason regarding why a communication is to be established. Examples of establishment causes can include the following: emergency, high priority access, mobile-terminated access, mobile-originated signaling, mobile-originated data, and so forth. Details regarding different establishment causes according to the UMTS or LTE protocol are described in 3GPP TS 25.331 or 36.331. In other examples, other establishment causes can be specified.

As further examples, in addition to or in place of establishment causes, connection types can also include call types, such as a call type specified by an upper layer of the mobile device. In some examples, such as according to LTE, this upper layer can be a non-access stratum (NAS) layer, which is a layer that provides various functionalities, including mobility management, session management, and so forth. Examples of call types that can be specified by an upper layer such as the NAS layer can include the following: emergency calls, mobile-terminating calls, mobile-originating calls, mobile-originating signaling, or mobile-originating circuit-switched fallback (CSFB) (which refers to a procedure that allows for a mobile device connected to a packet-switched only network, such as LTE, to switch to using a circuit-switched capable network, such as UMTS or GSM, for performing certain communications), and so forth.

The ability to configure different retry parameters for different network domains or connection types allows for more flexible control of retry behavior of mobile devices. For example, a network operator can decide to decrease the number of retries per time interval (such as by increasing retry time values or decreasing retry count values) by mobile devices in the packet-switched domain as compared to circuit-switched domain. Reducing the volume of retries in the packet-switched domain can potentially ease overall network congestion. As another example, a network operator can decide to allow certain connection types (such as an emergency call) to have a larger number of retries per time interval as compared to other connection types.

### Example Network Arrangement

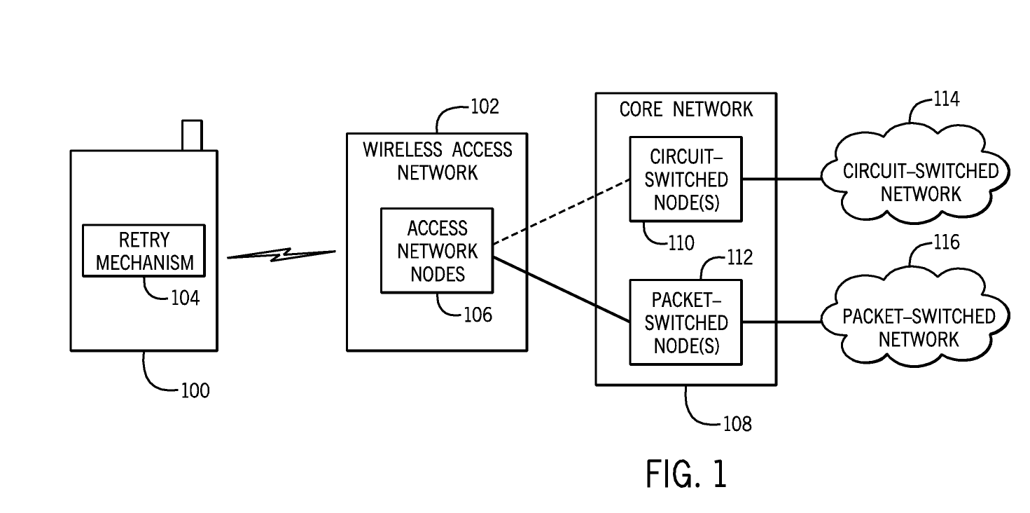

FIG. 1 is a block diagram of example network arrangement that includes a mobile device 100, a wireless access network 102, a core network 108, a circuit-switched network 114, and a packet-switched network 116. The mobile device 100 is able to attach to the wireless access network 102 to perform wireless communications. Although just one mobile device 100 is shown, note that multiple mobile devices 100 can attach to the wireless access network 102. Also, there can be multiple wireless access networks 102. The mobile device 100 includes a retry mechanism 104 according to some embodiments that use different retry parameter values for different network domains, or different connection types, or a combination of both (as discussed above).

In some examples, the wireless access network 102 can be a radio access network according to the UMTS access technology, which is referred to as a Universal Terrestrial Radio Access Network (UTRAN). In other examples, the wireless access network 102 can be an access network according to the LTE access technology; such a wireless access network can be referred to as an Evolved UTRAN (EUTRAN). In other examples, the wireless access network 102 can be according to another access technology.

The wireless access network 102 includes access network nodes 106. In a UTRAN, the access network nodes 106 can include node Bs, which are base stations used to communicate wirelessly with mobile devices. The access network nodes 106 of a UTRAN can also include radio network controllers (RNCs), which are used for controlling node Bs.

If the wireless access network 102 is an EUTRAN, the access network nodes 106 can include eNode Bs (or evolved node Bs). An eNode B can include functionalities of base stations as well as functionalities of radio network controllers.

The wireless access network 102 is coupled to the core network 108, which can include circuit-switched node(s) 110 and packet-switched node(s) 112. The circuit-switched node(s) 110 can be used to manage circuit-switched communications of the mobile device 100. The packet-switched node(s) 112 can be used to manage packet-switched communications of the mobile device 100.

In examples where wireless access network 102 is a UTRAN, the mobile device 100 is able to selectively establish communications in either the circuit-switched domain (including the circuit-switched node(s) 110 of the core network 108) or in the packet-switched domain (including the packet-switched node(s) 112 of the core network 108). Circuit-switched communications can be established with a remote endpoint that is coupled to the circuit-switched network 114. Packet-switched communications can be performed with an endpoint coupled to the packet-switched network 116.

According to LTE, however, the mobile device 100 is able to establish communications in just the packet-switched domain.

An example of a circuit-switched node 110 is a mobile switching center. Examples of packet-switched nodes 112 used with UMTS can include a serving GPRS (General Packet Radio Service) support node (SGSN) and a gateway GPRS support node (GGSN). In some examples, an SGSN can perform the following tasks: packet routing and transfer, mobility management, logical link management, and authentication and charging functions. A GGSN can convert packets between a format used by the SGSN and a of the packet-switched network 116.

Examples of packet-switched nodes 112 for LTE include a mobility management entity (MME), a serving gateway, and a packet data network (PDN) gateway. The MME is a control node that is responsible for various functionalities, including mobile device tracking and paging procedures, serving gateway selection, and user authentication. A serving gateway routes bearer data packets (containing data such as voice data, web browsing data, etc.), and acts as a mobility anchor during handovers between different nodes of the access network. A PDN gateway provides connectivity between the mobile device and a packet-data network, such the packet-switched network 116.

In other examples, other types of circuit-switched nodes 110 and packet-switched nodes 112 can be employed in the core network 108.

### Network Configuration of Retry Parameters

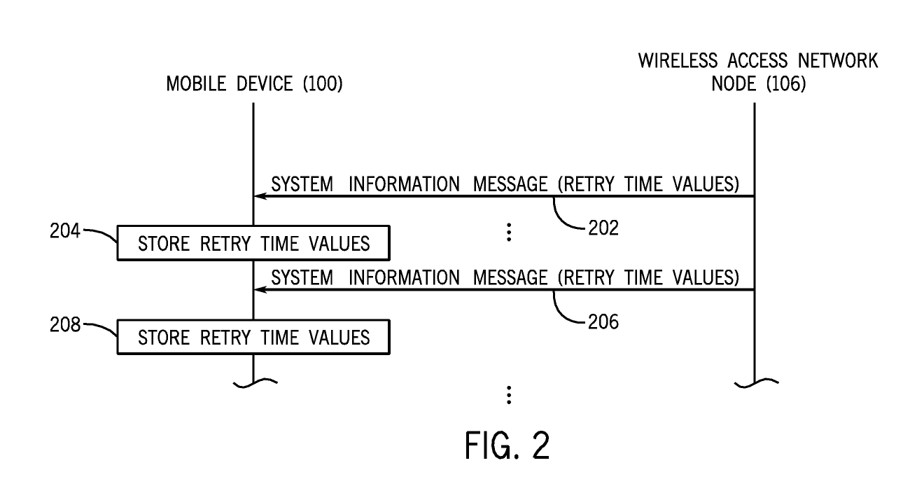

FIG. 2 a message flow diagram of a process of configuring retry parameters in accordance with some implementations. The process of FIG. 2 includes messaging exchanged between a mobile device 100 and a wireless access network node 106. The wireless access network node 106 sends (at 202) a system information message to the mobile device 100. The system information message can include different retry parameter values for different network domains or for different connection types. In some implementations, a first set of one or more retry parameter values (e.g. retry time value, retry count value) can be provided in the system information message for the circuit-switched domain, and a second set of one or more retry parameter values can be provided in the system information message for the packet-switched domain. Similarly, different sets of retry parameter values can be provided in the system information message for different connection types. As yet a further alternative, different sets of retry parameter values can be provided in the system information message based on different combinations of network domains and connection types.

In some examples, the retry time values can include a T300 parameter and T302 parameter as described in 3GPP TS 25.331 or 3GPP TS 36.331. The T300 parameter contains a value that is to be used for determining a retry time for the re-transmission of an access request from the mobile device to access the wireless access network 102 when the mobile device 100 is in idle mode (e.g. RRC idle mode). The T302 parameter contains a value that is used to determine a retry time when the mobile device is in a connected mode. In some examples, the system information message can include different sets of the T300 and T302 parameters for corresponding different network domains or different connection types.

In further examples, the system information message sent at 202 may include retry count values, which can be used to determine a maximum number of retry attempts that are to be performed. In some examples, according to UMTS, the retry count values can include an N300 parameter and an N302 parameter, to be used in idle mode and connected mode, respectively. The system information message can include different sets of N300 and N302 parameters for different network domains or different connection types.

It should be understood that the system information message may include retry time values, retry count values, or both retry time values and retry count values for various different network domains or different connection types.

An example content of a system information message can be as follows:
UE-IdleTimersAndConstants . . .
T300: value1
N300: value2
T302: value3
N302: value4
. . .
T300-ps: value5
N300-ps: value6
T302-ps: value7
N302-ps: value8.

The T300, N300, T302, and N302 parameter values can be for the circuit-switched domain, while the T300-ps, N300-ps, T302-ps, and N302-ps parameter values can be for the packet-switched domain. In other examples, different sets of T300, N300, T302, and N302 parameter values can be specified for different connection types (or alternatively, for different combinations of network domains and connection types) in a system information message. It should be understood that other retry parameters may be included in the system information message, including default retry parameters which may be used if specific retry parameters are not indicated for a particular connection type.

The retry parameter values contained in the system information message can be sent (at 202) by the wireless access network node 106 in the absence of any detected congestion in the wireless access network. In other words, the wireless access network node 106 does not have to wait for detection of congestion before retry parameter values are sent to the mobile device 100—the wireless access network node 106 can send the system information message with retry parameter values even if there is no detected congestion in the network. By not having to wait until detection of congestion occurs before sending a system information message with retry parameter values, the latency between detection of the congestion and the actual configuration of the retry parameter values in mobile devices can be avoided or reduced.

In some implementations, the wireless access network node 106 may send invalid retry parameter values that are outside of valid limits (e.g. setting retry time value to a negative value) to indicate that there is no congestion. A mobile device may ignore invalid retry parameters or may interpret the invalid retry parameters as an instruction to perform normal retry behavior.

Upon receiving the system information message, the mobile device 100 stores (at 204) the retry parameter values in a storage medium of the mobile device 100.

The wireless access network node 106 can, at a later time, send (at 206) another system information message that contains retry parameter values, which can be different from the retry parameter values in the system information message sent at 202. The system information message sent (at 206) can be in response to detection of congestion in the wireless access network, or alternatively, the system information message sent (at 206) can be due to passing of some predefined time period. If network congestion is detected, the retry parameter values in the system information message sent (at 206) can be modified (from prior retry parameter values) to cause reduction of a number of retries per time interval. For example, the system information message sent (at 206) may have a retry time value indicating a longer retry time period compared to the earlier system information message (at 202), or may have a lower retry count value compared to the earlier system information message (at 202).

Upon receiving the system information message sent (at 206), the mobile device 100 stores (at 208) the retry parameter values.

The process of FIG. 2 can continue, with the system information message sent by the wireless access network 102 repeatedly, such as periodically or in response to other events. Note that the retry parameter values can be semi-statically configured by a network operator, which can mean that once the retry parameter values are configured, then they do not change frequently. Alternatively, the retry parameter values can change in a more dynamic manner, such as in response to a current load condition of the wireless access network.

In some examples, the system information message (sent at 202 or 206) can include a System Information Block Type 1 or 2 (SIB1 or SIB2), as defined by 3GPP TS 25.331 or 36.331. Note that there can also be other types of system information blocks, such as System Information Block Type 4, System Information Block Type 5, and so forth.

In current standards, such as the UMTS Specifications, the T300 and T302 parameters are represented by four bits. In accordance with some embodiments, the number of bits to represent T300 and T302 can be increased to greater than four bits to provide the ability to represent larger time values, such that additional configuration flexibility can be provided for network operators.

The ability to control retry behavior by mobile devices for different network domains or connection types can also allow for increased fairness, in that the likelihood of a mobile device being barred from making further access attempts is reduced. The aggressiveness of retry behavior can be controlled for different network domains or connection types, and such control can be based on current network congestion conditions. Flexibility is also enhanced since retry behavior of mobile devices can be controlled in both idle mode and connected mode.

### UMTS Channel Establishment Procedures

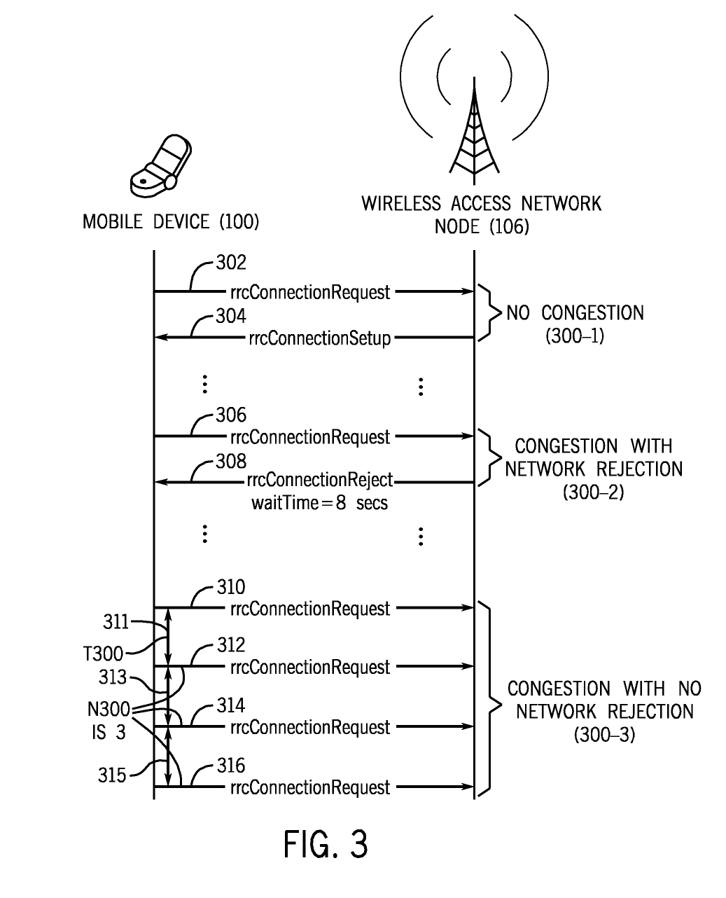

FIG. 3 is a message flow diagram showing example channel establishment procedures when the mobile device is in an idle mode (e.g. RRC idle mode). The example of FIG. 3 assumes the UMTS access technology is used. In FIG. 3, three example scenarios are depicted: (1) a scenario with no network congestion (300-1), (2) a scenario with network congestion where an affirmative rejection of an access request is received (300-2), and (3) a scenario with network congestion where no affirmative rejection of an access request is received (300-3).

In example scenario 300-1, a channel establishment procedure is initiated by the mobile device 100 sending (at 302) an rrcConnectionRequest message on the uplink to the wireless access network node 106. Since no congestion (or other issue) is present that prevents successful completion of the channel establishment procedure, the wireless access network node 106 responds by sending (at 304) an rrcConnectionSetup message on the downlink to the mobile device 100. The rrcConnectionSetup message allocates radio resources for the channel establishment procedure to be completed.

In example scenario 300-2, congestion prevents successful completion of the channel establishment procedure. In such scenario, in response to an rrcConnectionRequest message sent (at 306) on the uplink and the wireless access network node 106 determining that the wireless access network 102 has available resources to be able to reply to the rrcConnectionRequest message, the wireless access network node 106 sends (at 308) an rrcConnectionReject message on the downlink, which includes an information element indicating the cause of rejection as “congestion.” The rrcConnectionReject message can include an information element containing a wait time, which is the wait time to be used by the mobile device 100 before sending another rrcConnectionRequest message. Alternatively, the rrcConnectionReject message can re-direct the mobile device 100 to another cell, frequency or radio access technology (RAT). In response to the rrcConnectionReject message, the mobile device 100 can initiate re-transmission after either the specified wait time has expired or the mobile device 100 has attached to the new cell or access technology.

In the example of FIG. 3, it is assumed that the rejection message (e.g. rrcConnectionReject message) contains a wait time. In other examples, the rejection message may not include a wait time—in such situation, a channel establishment retry procedure performed by the mobile device can use network-configured retry parameters, similar to the retry procedure for scenario 300-3 discussed below.

In example scenario 300-3, congestion prevents successful completion of the channel establishment procedure, but no response from the network is received by the mobile device 100, either because the wireless access network node 106 did not detect an rrcConnectionRequest message sent (at 310) on the uplink, or the network node did not have available resources to be able to reply to the rrcConnectionRequest message or the network node's response (e.g. rrcConnectionReject) was not received by the mobile device 100 on the downlink. In such scenario, the mobile device 100 can perform a connection establishment retry procedure that uses the network-configured retry parameter values conveyed in a system information message, such as System Information Block Type 1.

For example, upon transmitting the rrcConnectionRequest message (at 310), the mobile device 100 starts a T300 timer (a timer in the mobile device 100 that expires after the T300 retry time). Upon expiration of the T300 timer without receiving an acknowledgment (e.g. rrcConnectionReject or rrcConnectionSetup) from the wireless access network node 106, the mobile device 100 transmits (at 312) another rrcConnectionRequest message. The delay time (311) between successive transmissions (310, 312) of the rrcConnectionRequest messages is referenced by 311, and is based on the T300 value.

As further shown in FIG. 3, subsequent retry attempts can be made (by re-transmitting rrcConnectionRequest messages at 314 and 316), with respective retry times 313 and 315 between successive transmissions of the rrcConnectionRequest messages. When a maximum number of retry attempts (based on N300, for example) have been made, then no further retries are made.

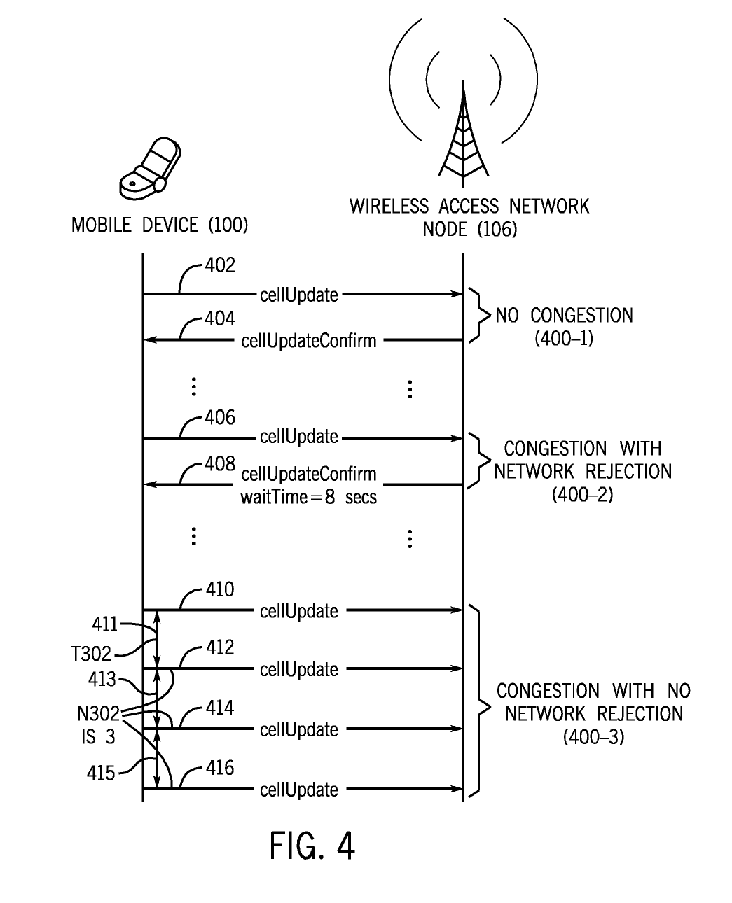

In a different example, as shown in FIG. 4, the mobile device 100 can be in a connected mode (e.g. RRC CELL_PCH or URA_PCH state). In this case, a different message is used by the mobile device 100 to request access of the wireless access network 100. In the example in FIG. 4, it is assumed that the wireless access technology used is UMTS. FIG. 4 shows channel establishment procedures in three scenarios 400-1, 400-2, and 400-3, which are the same scenarios as 300-1, 300-2, and 300-3, respectively, of FIG. 3.

When the mobile device 100 is in a connected mode, a channel establishment procedure is initiated by the mobile device 100 sending (at 402) a cellUpdate message on the uplink. If the wireless access network 102 can successfully establish the channel connection (example scenario 400-1), the wireless access network node 106 responds to the cellUpdate message by sending (at 404) a cellUpdateConfirm message. In normal operation (e.g. non-congested operation), the cellUpdateConfirm message allocates radio resources for the channel establishment procedure to be completed.

In example scenario 400-2, where congestion exists, the wireless access network node 106 responds to a cellUpdate message sent (at 406) on the uplink by transmitting (at 408) a cellUpdateConfirm message that contains a wait time that specifies the delay time that the mobile device 100 is to wait before sending another access request. The cellUpdateConfirm message with a wait time is considered a network rejection of the cellUpdate message sent (at 406). Alternatively, the cellUpdateConfirm message can re-direct the mobile device 100 to another frequency or radio access technology. In different examples, the cellUpdateConfirm message for rejecting the cellUpdate message may not include a wait time, in which case the mobile device 100 can use the network-configured retry parameter values in a channel establishment retry procedure, similar to the retry procedure for scenario 400-3 discussed below.

In example scenario 400-3, network congestion is present, but the mobile device 100 does not receive a rejection message. In response to a cellUpdate message sent (at 410) by the mobile device 100, the mobile device 100 performs a channel establishment retry procedure similar to the channel establishment retry procedure of FIG. 3. In the FIG. 4 example, since the mobile device 100 is in a connected mode, the mobile device 100 uses the T302 and N302 parameters in the channel establishment retry procedure, where N302 retry attempts (cellUpdate messages transmitted at 412, 414, and 416) are made, and a T302 time period (411, 413, and 415) is used between successive transmissions of the cellUpdate messages.

### LTE Channel Establishment Procedures

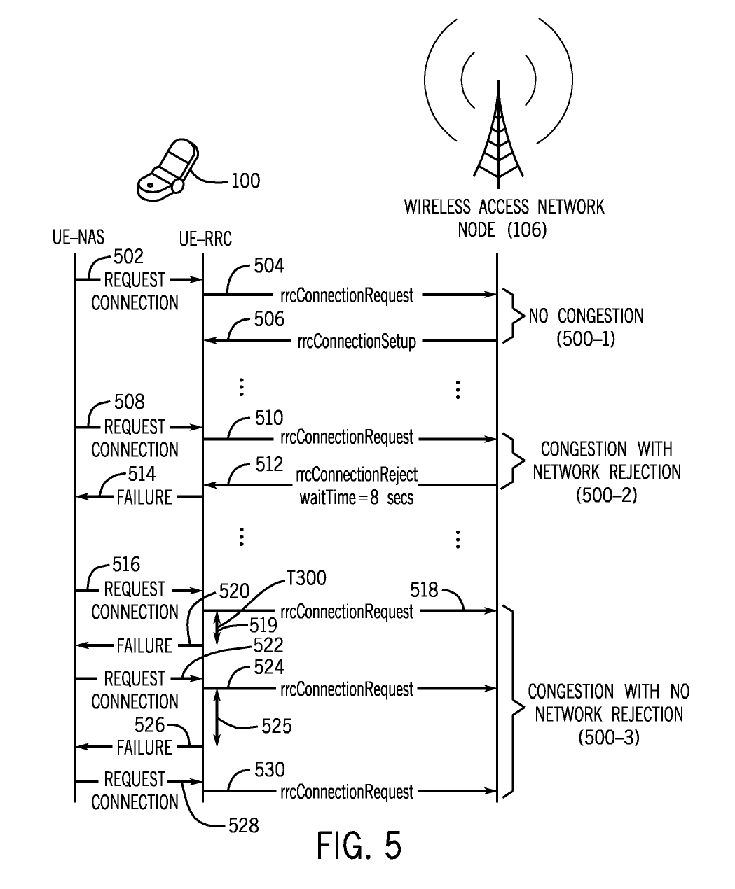

FIG. 5 illustrates channel establishment procedures under different conditions when the LTE access technology used. FIG. 5 shows three example scenarios 500-1, 500-2, and 500-3, which are the same as example scenarios 300-1, 300-2, and 300-3, respectively, of FIG. 3.

According to LTE, the T300 parameter can be used, but the T302, N300 and N302 parameters are not used as part of the channel establishment procedure. FIG. 5 shows channel establishment procedures according to LTE when the mobile device 100 is in idle mode (such that the T300 parameter is used for a channel establishment retry procedure).

FIG. 5 also shows communications between a non-access stratum (NAS) layer and RRC layer of the mobile device 100. The NAS layer is a protocol layer that includes various protocols for communication of control plane signaling between the mobile device 100 and the MME in the core network 108. Some example functionalities of the NAS layer include mobility support of mobile devices and support of session management procedures. The RRC layer handles control plane signaling between the mobile device 100 and the wireless access network node 106.

According to LTE, when the mobile device's NAS layer requests (at 502) establishment of a connection, the RRC layer sends (at 504) an rrcConnectionRequest message on the uplink to the wireless access network node 106. In example scenario 500-1, where no network congestion is present, the wireless access network node 106 responds by sending (at 506) an rrcConnectionSetup message. The rrcConnectionSetup message allocates radio resources for the channel establishment procedure to be completed.

In example scenario 500-2, network congestion prevents successful completion of a channel establishment procedure. When the mobile device's NAS layer requests (at 508) establishment of a connection, the RRC layer sends (at 510) an rrcConnectionRequest message on the uplink to the wireless access network node 106. The wireless access network node 106 responds by sending (at 512) an rrcConnectionReject message (which can contain a wait time). In response, the RRC layer provides (at 514) a failure indication to the NAS layer.

In the foregoing example of scenario 500-2, it is assumed that the rejection message (e.g. rrcConnectionReject message) contains a wait time. In other examples, the rejection message may not include a wait time—in such situation, a channel establishment retry procedure performed by the mobile device can use network-configured retry parameters, similar to the retry procedure for scenario 500-3 discussed below.

In example scenario 500-3, network congestion prevents successful completion of a channel establishment procedure, but the mobile device 100 does not receive a rejection message. In response, the mobile device 100 performs a channel establishment retry procedure that uses the T300 retry time value. When the RRC layer sends (at 518) an rrcConnectionRequest message in response to a connection request (at 516) from the NAS layer, the RRC layer starts the T300 timer. Upon expiration of the T300 timer (519) without receiving an acknowledgment (rrcConnectionReject or rrcConnectionSetup message), the RRC layer provides (at 520) a failure indication to the NAS layer. In response, the NAS layer provides (at 522) another connection request, which causes the RRC layer to re-transmit (at 524) another rrcConnectionRequest message. Expiration of the T300 timer (525) after the re-transmission (at 524) causes another failure indication (526), followed by another connection retry (528, 530). According to LTE, the NAS layer is permitted to provide a fixed number (equal to 5, for example) of connection requests in this way before it has to stop. Thus LTE can be considered to have a fixed value of 5 for the retry count value, and further the retry counting is performed within the NAS layer rather than the RRC layer, as is the case with UMTS.

### Providing Different Sets of Parameter Values for Different Connection Types

As noted above, LTE supports mobile device connection to just the packet-switched domain. Thus, according to LTE, instead of specifying different sets of retry parameter values for different network domains, different sets of retry parameter values can be specified for different connection types in a system information message. Note that specifying different sets of retry parameter values for different connection types can also be performed when the UMTS or other access technology is used.

Different connection types can be specified by an establishment cause in an access request, such as an rrcConnectionRequest message. According to 3GPP TS 36.331, the following establishment causes can be specified in the rrcConnectionRequest message: emergency, high priority access, mobile-terminated access, mobile-originated signaling, mobile-originated data, and so forth. In specific examples, the wireless access network can configure different connection establishment retry behavior (e.g. by configuring a different T300 value) for “emergency” and “high priority access” to differentiate a priority of these connection types over other connection types (other establishment causes).

In different examples, such as for UMTS, 3GPP TS 25.331 can specify other establishment causes.

More generally, multiple sets of retry time values can be established for different establishment causes, such as according to the examples below.
Establishment cause=emergency or high priority access, use value set A (e.g. T300A);
Establishment cause=mobile-terminated access or mobile-originated signaling, use value set B (e.g. T300B);
Establishment cause=mobile-originated data, use value set C (e.g. T300C);
Any other establishment cause, use value set D (e.g. T300D).

A further example, this time for UMTS, is given below. Note that in the UMTS example, the channel establishment retry behavior can be further elaborated to consider a combination of the network domain as well as the establishment cause, such as in the following examples.
Network domain=circuit-switched, and establishment cause=emergency, use value set A (e.g. T300A, N300A, T302A, N302A);
Network domain=circuit-switched, and establishment cause=originating conversational call, originating streaming call, terminating conversational call, or terminating streaming call, use value set B (e.g. T300B, N300B, T302B, N302B);
Network domain=circuit-switched, and establishment cause=any other cause value, use value set C (e.g. T300C, N300C, T302C, N302C);
Network domain=packet-switched, and establishment cause=originating conversational call, originating streaming call, terminating conversational call, or terminating streaming call, use value set D (e.g. T300D, N300D, T302D, N302D);
Network domain=packet-switched, and establishment cause=originating interactive call, or terminating interactive call, use value set E (e.g. T300E, N300E, T302E, N302E);
In all other cases, use value set F (e.g. T300F, N300F, T302F, N302F).

In addition to being able to specify an establishment cause set by the NAS layer when the NAS layer requests the establishment of a connection, in LTE the NAS layer can also set a call type to be one of the following: emergency call, mobile terminating call, mobile originating call, mobile originating signaling, or mobile originating circuit-switched fallback. In addition to or in place of using establishment causes, the call type specified by the NAS layer can be used to determine the retry parameter value to apply.

Furthermore, it is also possible that other information may be available within the NAS layer, and is not currently made available to the RRC layer—such other information can also be provided to the RRC layer for the purpose of determining, possibly in combination with the call type and establishment cause, the retry parameter value to apply.

In a further example, for LTE, it is possible that the fixed retry count value of 5 (as discussed above), can be replaced by a retry count value that is dependent on different connection types. The retry count value can be set dependent on the establishment cause, the call type or other information available within the NAS layer. The different retry count values for the different connection types can be provided to the mobile device in the same way as the different retry time values in a system information message. As the system information message is received by the RRC layer of the mobile device, the RRC layer can pass the retry count values obtained from this message to the NAS layer of the mobile device where the mobile device performs the retry counting. Alternatively, the different retry count values can be provided directly to the NAS layer of the mobile via NAS layer messages, for example the Attach Accept or Tracking Area Update Accept messages.

### Implementing Network-Signaled Specific Retry Parameters

The following describes various example ways to implement network domain or connection type specific retry parameter values. Note that the following is provided for purposes of example, as other modifications can be made in other implementations.

Network Domain Specific Retry Parameter Values

The following describes various system information message information elements that may be used to implement the specification of different sets of retry parameter values for different network domains (circuit-switched domain and packet-switched domain). In the ensuing discussion, “UE” refers to “user equipment,” and can refer to a mobile device or other electronic device that is capable of attaching to a wireless access network.

A system information message may include the following information elements (and respective values):

| Information | | Type and | Semantics |
|---|---|---|---|
| Element/Group name | Need | reference | description |
| T300/N300 for PS | Optional | | |
| domain | | | |
| >T300-ps | Mandatory present | Integer(100, | Value in |
| | | 200 . . . 2000 | milliseconds. |
| | | by step of | |
| | | 200, 3000, | |
| | | 4000, 6000, | |
| | | 8000, 10000, | |
| | | 12000) | |
| >N300-ps | Mandatory present | Integer(0. .7) | |

A UE may be configured to parse the system information message. If the IE (information element) “T300/N300 for PS domain” is stored in the IE “UE Timers and constants in idle mode” in the variable TIMERS_AND_CONSTANTS and the UE is attempting to establish a signaling connection to the PS (packet-switched) domain and is not attempting to establish a signaling connection to the CS (circuit-switched) domain, then the UE may apply the value of T300-ps for the value of T300, and the value of N300-ps for the value of N300 for an RRC connection establishment procedure.

A system information message may include the following information elements (and respective values):

| Information | | Type and | Semantics |
|---|---|---|---|
| Element/Group name | Need | reference | description |
| T302/N302 for PS | Optional | | |
| domain | | | |
| >T302-ps | Mandatory present | Integer(100, | Value in |
| | | 200 . . . 2000 | milliseconds. |
| | | by step of | |
| | | 200, 3000, | |
| | | 4000, 6000, | |
| | | 8000, 10000, | |
| | | 12000) | |
| >N302-ps | Mandatory present | Integer(0. .7) | |

A UE may be configured to parse the system information message. When initiating the URA update or cell update procedure, if the IE (information element) “T302/N302 for PS domain” is stored in the IE “UE Timers and constants in connected mode” in the variable TIMERS_AND_CONSTANTS, and a signaling connection for the CS domain does not exist in the variable ESTABLISHED_SIGNALLING_CONNECTIONS, and the UE is not attempting to establish a signaling connection to the CS domain, then the UE may apply the value of T302-ps for the value of T302, and the value of N302-ps for the value of N302 for a RRC URA update or cell update procedure.

In some examples, such as shown by the examples given above, new T300-ps and N300-ps values are either both present in system information message or neither are present. A variant is possible in which the T300-ps and N300-ps parameters are independent optional information elements in the system information message. The same approach can be applied to the T302-ps and N302-ps parameters.

For the RRC connection establishment procedure, the UE initiates the procedure for the purpose of establishing a signaling connection to either the packet-switched domain or the circuit-switched domain, or both. With the examples provided above, if the UE is attempting to establish an RRC connection to establish signaling connection to both circuit-switched and packet-switched domains, then the UE can apply the T300/N300 parameters that are appropriate for the circuit-switched domain.

The cell update procedure (initiated with a cellUpdate message) may be triggered for reasons that may not be associated with either the circuit-switched domain or the packet-switched domain. Such examples include cell reselection, radio link failure, re-entering a service area, RLC (radio link control) unrecoverable error, and periodic update. For these cases, it may be considered whether the packet-switched or circuit-switched values of T302/N302 are used.

In examples provided above, the T302-ps/N302-ps values are used if the UE only has a signaling connection to the packet-switched domain and the UE is not attempting to establish a signaling connection to the circuit-switched domain. Thus any cell update performed at the start of a circuit-switched call, or during an ongoing circuit-switched call (for example, as a result of a radio link failure) would result in the T302/N302 values appropriate to the circuit-switched domain being used.

It is possible that during an RRC connection establishment procedure or a cell update procedure that is using the packet-switched domain retry parameter values, there is a request from an upper layer of the mobile device to establish a connection to the circuit-switched domain. According to the examples provided above, the UE would continue to use the packet-switched domain retry parameter values. However, a variant of this behavior is possible where the UE, upon receiving a request to establish a connection to the circuit-switched domain, switches to using the circuit-switched domain retry parameter values. This switch to the circuit-switched domain retry parameter values can occur immediately, or it can occur at the next transmission of an rrcConnectionRequest message or cellUpdate message; alternatively, the current ongoing procedure can be aborted and a new procedure (using the new values) can be started.

Note that when the UE sends a cellUpdate message when the UE is attempting to establish a signaling connection to the circuit-switched domain, the cellUpdate message may include an establishment cause (that is set to the same value as for the case when the UE is initially in RRC idle mode and sending an rrcConnectionRequest message). Furthermore, in the case of a mobile originating circuit-switched call, the UE may also include a call type that can be set to “video” or “voice” depending on the type of call being originated. Both the establishment cause and the call type can be provided by the NAS layer to the RRC layer. Thus the UE RRC layer can use this information provided by the NAS layer to determine that the UE is attempting to establish a signaling connection to the circuit-switched domain.

Connection Type Specific Retry Parameter Values

The following describes various system information message information elements that may be used to implement the specification of different sets of retry parameter values for different connection types.

A system information message may include the following information elements (and respective values):

| Information | | Type and | Semantics |
|---|---|---|---|
| Element/Group name | Need | reference | description |
| T300/N300 lower priority | Optional | | |
| >T300-Ip | Mandatory present | Integer(100, | Value in |
| | | 200 . . . 2000 | milliseconds. |
| | | by step of | |
| | | 200, 3000, | |
| | | 4000, 6000, | |
| | | 8000, 10000, | |
| | | 12000) | |
| >N300-Ip | Mandatory present | Integer(0. .7) | |

A UE may be configured to parse the system information message. If the IE “T300/N300 lower priority” is stored in the IE “UE Timers and constants in idle mode” in the variable TIMERS_AND_CONSTANTS, and the variable ESTABLISHMENT_CAUSE is set to one of “Originating Interactive Call,” “Originating Background Call,” “Terminating Interactive Call,” “Terminating Background Call,” “Originating Low Priority Signaling,” “Terminating Low Priority Signaling,” or “Delay Tolerant Access” then the UA may apply the value of T300-Ip for the value of T300, and the value of N300-Ip for the value of N300 for this RRC connection establishment procedure.

The T300-Ip and N300-Ip values are “low priority” values that can be used for certain selected connection types. The T300-Ip and N300-Ip values are different from respective T300 and N300 values used for other connection types.

A system information message may include the following information elements (and respective values):

| Information | | Type and | Semantics |
|---|---|---|---|
| Element/Group name | Need | reference | description |
| T302/N302 lower priority | Optional | | |
| >T302-Ip | Mandatory present | Integer(100, | Value in |
| | | 200 . . . 2000 | milliseconds. |
| | | by step of | |
| | | 200, 3000, | |
| | | 4000, 6000, | |
| | | 8000, 10000, | |
| | | 12000) | |
| >N302-Ip | Mandatory present | Integer(0. .7) | |

A UE may be configured to parse the system information message. When initiating a cell update procedure, if the IE “T302/N302 lower priority” is stored in the IE “UE Timers and constants in connected mode” in the variable TIMERS_AND_CONSTANTS, and if the cell update cause value is “uplink data transmission,” “paging response,” “re-entering service area,” “cell reselection,” or “periodic cell update” and the variable ESTABLISHMENT_CAUSE is not set or is set to one of “Originating Interactive Call,” “Originating Background Call,” “Terminating Interactive Call,” “Terminating Background Call,” “Originating Low Priority Signaling,” “Terminating Low Priority Signaling,” or “Delay Tolerant Access” then the UE may apply the value of T302-Ip for the value of T302, and the value of N302-Ip for the value of N302 for this cell update procedure.

The following variants refer to changes to a system information message to support different retry parameter sets for different connection types.

A first variant specifies how the T300 value may be selected based on the establishment cause value that is provided by an upper layer. In the first variant, a lower priority T300-Ip value is used for establishments causes “mobile-terminated access,” “mobile-originated signaling,” “mobile-originated data,” and “delay tolerant access.” An existing T300 value can be used for establishment causes “emergency” and “high priority access.”

A UE performing an RRC connection establishment procedure may interpret the values in the system information message. If T300-Ip is present in UE-TimersAndConstants, and the value of establishmentCause provided by upper layers is “mobile-terminated access,” “mobile-originated signaling,” “mobile-originated data,” or “delay tolerant access” then the UE may apply the value of T300-Ip for the value of T300 for this RRC connection establishment procedure.

A second variant specifies how the T300 value may be selected based on the call type provided by an upper layer. In this example, a lower priority T300-Ip value can be used for call types “mobile originating calls” and “mobile originating signaling,” and an existing T300 value can be used for call types “mobile terminating calls,” “emergency calls,” and “mobile originating circuit-switched fallback.” Note that it would be possible to create a further variant that combines the use of establishment cause and call type.

For the second variant, if the T300-Ip is present in UE-TimersAndConstants, and the UE is not establishing the RRC connection for any of a mobile terminating call, an emergency call, or mobile originating circuit-switched fallback, the UE may apply the value of T300-Ip for the value of T300 for this RRC connection establishment procedure.

For both variants above, the following information element (and corresponding assigned value) may be included in a system information message:
T300-Ip. ENUMERATED {ms100, ms200, ms300, ms400, ms600, ms1000, ms1500, ms2000, ms3000, ms4000, ms5000, ms8000}, OPTIONAL

### Example System Arrangement

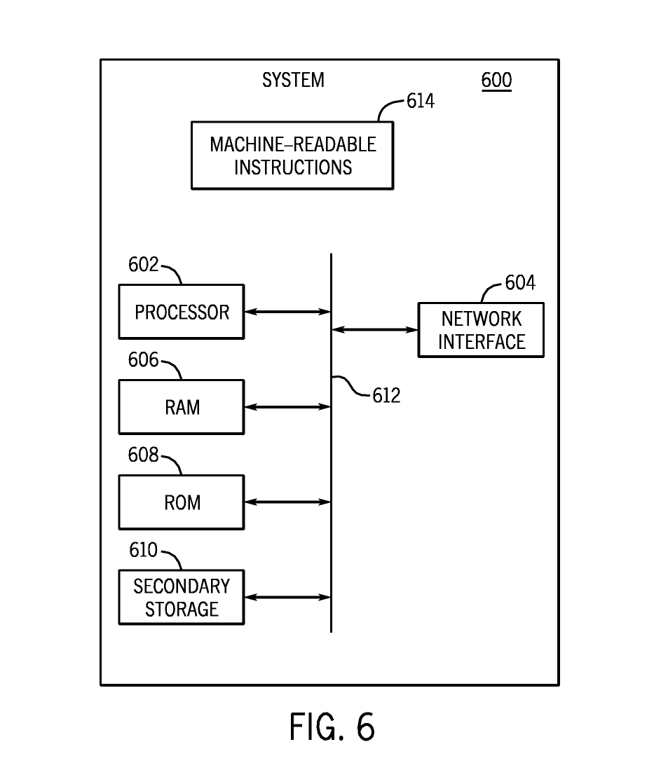

FIG. 6 illustrates an example system 600, which can either be the mobile device 100 or an wireless access network node 106 depicted in FIG. 1. The system 600 includes a processor (or multiple processors) 602. A processor can include a microprocessor, microcontroller, processor module or subsystem, programmable integrated circuit, programmable gate array, or another control or computing device.

The system 600 can also include a network interface 604, to allow the system 600 to communicate over a wireless link, such as the wireless link between the mobile device 100 and the wireless access network 102. The system 600 can also include various storage media, including a random access memory (RAM) 606 (e.g. dynamic RAM or static RAM), read-only memory (ROM) 608 (e.g. erasable and programmable read-only memory (EPROM), electrically erasable and programmable read-only memory (EEPROM), or flash memory), and secondary storage 610 (e.g. magnetic disk such as fixed, floppy and removable disks; optical medium such as a compact disk (CD) or digital video disk (DVD), and so forth). The various components can communicate with each other over one or more buses 612.

Machine-readable instructions 614 in the system 600 are executable on the processor(s) 602 to perform the various tasks discussed above. The machine-readable instructions 614 can be stored in any of the various storage media (e.g. 606, 608, 610) of the system 600.

In alternative embodiments, a method of a wireless access network node comprises sending a system information message to an electronic device, the system information message including corresponding retry time values for a plurality of network domains, the plurality of network domains including a packet-switched domain and a circuit-switched domain.

In further embodiments, an article comprising at least one machine-readable storage medium stores instructions that upon execution cause a wireless access network node to send a system information message to an electronic device, the system information message including corresponding retry time values for a plurality of connection types; receive, from the electronic device, a first request to access the network according to a particular connection type; and receive, from the electronic device, a second request to access the network delayed by at least a retry time period based upon a retry time value corresponding to the particular connection type.

In yet further embodiments, a wireless access network node comprise at least one processor to send a system information message to an electronic device, the system information message including corresponding retry time values for different network domains, for different connection types, or for different combinations of network domains and connection types, where each of the retry time values is useable by the electronic device to determine a delay time period between transmissions of successive requests to access the network by the electronic device.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of an electronic device, the method comprising:
receiving a system information message from a network, the system information message including corresponding retry time values for a plurality of network domains, the plurality of network domains including a packet-switched domain and a circuit-switched domain.

2. The method of claim 1, wherein the retry time values include a first retry time value corresponding to the packet-switched domain and a second retry time value corresponding to the circuit-switched domain.

3. The method of claim 2, wherein the first retry time value is different from the second retry time value.

4. The method of claim 1, further comprising:
sending a first request to access the network in a particular network domain; and
delaying a subsequent request to access the network for at least a retry time period based upon a retry time value corresponding to the particular network domain.

5. The method of claim 4, further comprising:
determining the retry time period responsive to receiving the system information message.

6. The method of claim 4, further comprising:
determining that the electronic device did not receive a response to the first request; and
sending the subsequent request in response to determining that the electronic device did not receive the response.

7. The method of claim 6, wherein determining that the electronic device did not receive the response is based on expiration of the retry time period.

8. The method of claim 7, wherein the electronic device did not receive the response to the first request due to congestion of the network.

9. The method of claim 4, wherein the first request is one of an rrcConnectionRequest and a CellUpdate message.

10. The method of claim 4, further comprising:
receiving a rejection message in response to the first request; and
in response to the rejection message responsive to the first request, transmitting the subsequent request after the delaying.

11. The method of claim 1, wherein the system information message is broadcast by the network to a plurality of electronic devices.

12. The method of claim 1, wherein the corresponding retry time values in the system information message are for different respective combinations of the network domains and connection types.

13. The method of claim 1, wherein the network includes one of a Universal Terrestrial Radio Access Network (UTRAN) and an Evolved UTRAN (EUTRAN).

14. The method of claim 1, wherein the system information message further includes corresponding retry count values for the plurality of network domains, where each of the retry count values specifies a respective maximum number of retries that the electronic device can perform for a particular network domain.

15. A method of an electronic device, comprising:
receiving a first system information message from a network, the first system information message including corresponding retry time values for a plurality of connection types;
sending a first request to access the network according to a particular connection type; and
delaying a subsequent request to access the network for at least a retry time period based upon a retry time value corresponding to the particular connection type.

16. The method of claim 15, wherein the first request is one of an rrcConnectionRequest and a CellUpdate message.

17. The method of claim 15, wherein receiving the first system information message comprises receiving the first system information message sent by the network in an absence of congestion of the network.

18. The method of claim 15, wherein the connection types are associated with respective establishment causes.

19. The method of claim 15, wherein the connection types are associated with respective call types.

20. The method of claim 15, further comprising:
receiving a second system information message from the network at a later time, the second system information message including a plurality of retry time values for corresponding connection types.

21. The method of claim 20, wherein receiving the second system information message is in response to occurrence of congestion of the network.

22. The method of claim 20, wherein at least one of the retry time values in the second system information message is larger than a corresponding one of the retry time values in the first system information message.

23. The method of claim 15, wherein the network includes one of a Universal Terrestrial Radio Access Network (UTRAN) and an Evolved UTRAN (EUTRAN).

24. The method of claim 15, wherein the first system information message further includes corresponding retry count values for the plurality of connection types, where each of the retry count values specifies a respective maximum number of retries that the electronic device can perform for a particular connection type.

25. An article comprising at least one machine-readable storage medium storing instructions that upon execution cause an electronic device to:
receive a system information message from a network, the system information message including corresponding retry time values for different network domains, for different connection types, or for different combinations of network domains and connection types, where each of the retry time values is useable by the electronic device to determine a delay time period between transmissions of successive requests to access the network by the electronic device.

26. The article of claim 25, wherein the different network domains include a circuit-switched domain and a packet-switched domain.

27. The article of claim 25, wherein the different connection types include respective one or more of different establishment causes and call types.

28. An electronic device comprising:
at least one processor configured to
receive a system information message from a network, the system information message including corresponding retry time values for different network domains, for different connection types, or for different combinations of network domains and connection types.

29. The electronic device of claim 28, wherein the processor is further configured to:
send a first request to access the network,
determine a retry time period based upon retry time values included in the system information message and the network domain or connection type associated with the first request, and
delay a subsequent request to access the network for at least the determined retry time period.
